(19) United States
(12) Patent Application Publication
(10) Pub. No.: US 2005/0119366 A1
(43) Pub. Date: Jun. 2, 2005

(54) UV-curing thiolenes for pressure sensitive and hotmelt adhesives

(75) Inventors: Thomas M. Moy, Hilliard, OH (US); David Day, Columbus, OH (US); Jeffrey Warmkessel, Worthington, OH (US)

Correspondence Address: CONNOLLY BOVE LODGE & HUTZ LLP, SUITE 800, 1990 M STREET NW, WASHINGTON, DC, 20036-3425, US

(73) Assignee: Ashland Inc., Ashland, KY (US)

(21) Appl. No.: 10/722,478

(22) Filed: Nov. 28, 2003

(51) Int. Cl. C08G 2/00

(52) U.S. Cl. 522/173

(57) ABSTRACT

Thiolene-curing adhesive formulations, methods of preparation, and uses thereof are provided.

### FIELD OF THE INVENTION

The present invention relates generally to pressure sensitive adhesives (PSA) and hotmelt adhesives (HMA), and particularly, but not by way of limitation, to UV-curable PSA and HMA. More particularly, the present invention relates to UV-curable PSA and HMA that are essentially 100% reactive without requiring an external photoinitiator.

### BACKGROUND

The information provided below is not admitted to be prior art to the present invention, but is provided solely to assist the understanding of the reader.

UV-curing pressure sensitive adhesives (PSA) and hotmelt adhesives (HMA) potentially offer a cost-effective, high-productivity alternative to conventional solvent-based or waterborne adhesive technologies. UV-curing PSAs are commonly comprised of an acrylate-functionalized urethane or other oligomer, blended with acrylate monomers, photoinitiators, and various additives to aid processing. Rapid conversion from an unreacted liquid to a solid, crosslinked adhesive is essential. Oxygen inhibition of the acrylate reaction can be a problem in these systems, leading to incomplete polymerization and inferior performance properties. Additionally, the comparatively high levels of photoinitiator that are often required are undesirable from an economic standpoint. Photoinitiators are often the most costly component of PSA formulations. Moreover, residual photoinitiator, and/or fragments thereof may potentially contribute to fugitive emissions during cure and/or, over time, may leach from the cured adhesive film with potentially adverse environmental effects.

Conventional UV-curable PSA and HMA do not have temperature resistance above 400° F. The published literature suggests that UV-curable PSAs can maintain adhesion and some other properties at temperatures of up to 350° F. Thermoplastic HMAs are essentially non-functional at temperatures above 200° F., although some crosslinking, reactive HMAs may perform above 300° F. Silicone adhesives and sealants are commonly used in applications where the temperature exceeds 400° F. Moreover, silicones are known to maintain flexible bond lines and good properties at temperatures as high as 500° F.

From about the early 1940s it has been known that heating or photolysis of a mixture of a di-functional thiol and a di-functional ene results in the formation of linear polymers. The polymerization proceeds by a step growth type free-radical chain mechanism. (See Hoyle et al., Photopolymerization of Thiol-Enes: Some Recent Advances, available online at http://www.radtech-europe.com/download/hoylepaperjanuary.pdf). Morgan and Ketley showed that a crosslinked network having a high degree of functional group conversion was obtained by exposing a mixture of multifunctional thiols and multifunctional enes to the ultraviolet light produced by a high-intensity, medium-pressure mercury lamp. [C. R. Morgan, F. Magnotta, and A. D. Ketley, 15 J. Polym. Sci.: Polym. Chem. Ed. 627 (1977); C. R. Morgan, and A. D. Ketley, 16 J. Polym. Sci.: Polym. Lett. Ed. 75 (1978)]. Typically, a photoinitiator, such as benzophenone, was used to abstract a hydrogen atom from the thiol, resulting in a thiyl (RS.) radical capable of initiating a free-radical chain polymerization process. A general kinetic depiction for free-radical curing of thiol-enes built around this two step propagation process is shown in FIG. 1.

Thiol-ene polymerizations proceed by a two-step propagation sequence. First, a thiyl radical adds into the ene (a carbon-carbon double bond functionality) to generate a carbon-centered radical. Second, the carbon-centered radical abstracts a hydrogen atom from a thiol, generating a further thiyl radical able to continue chain propagation. Following the generation of the initial thiyl radical, the thiol-ene propagation essentially involves a free-radical addition step (propagation 1) followed by a chain transfer step (propagation 2) and effectively produces an addition of a thiol (RSH) across a carbon-carbon double bond. The thiol operates as a chain transfer agent that limits the chain propagation to a single step. Therefore, high molecular-weight, crosslinked polymers are produced when the ene to thiol ratio is close to unity and when molecules with at least two functional groups are used. Moreover, the gel point of thiol-ene free-radical polymerizations (the point at which an infinite network is produced) is predicted to occur according to equation 1, as is standard for step growth gelation.
α=[1/r(fₜₕᵢₒₗ−1)(fₑₙₑ−1)]^{1/2} (1)
According to Equation 1, α is the fractional conversion required to attain an infinite gel network, r is the stoichiometric thiol/ene functionality ratio, fₜₕᵢₒₗ is the thiol functionality, and fₑₙₑ is the ene functionality.

Because the peroxy radicals that are formed by reaction of oxygen with the carbon centered radicals readily abstract a hydrogen from a thiol to continue the free-radical chain process, there is little oxygen inhibition of the free-radical polymerization of thiol-enes. In contrast, oxygen inhibition readily occurs with acrylate based radical polymerization processes since there is only one propagation step (reaction of a carbon centered radical chain end with the double bond of a monomer) and no facile hydrogen abstraction process as occurs in propagation step 2 in Scheme I.

Scheme I. General Thiol-Ene Photopolymerization Process.

| Step | Reactants | Products |
|---|---|---|
| Initiation | RSH + PI (if used) | RS° + other products |
| Propagation I | RS° + H₂C = CHR′ | RSH₂C° − CHR′ |
| Propagation II | RSH₂C° − CHR′ + RSH | RSH₂C − CH₂R′ + RS° |
| Termination | RS° + RS° | RSSR |

The present invention incorporates diisocyanates into the urethane oligomers used for the thiolene reaction.

“Thiolene” chemistry is a known technology and generically describes the facile reaction of mercaptan (RSH, thioalcohol, thiol) functional compounds with various classes of unsaturated organic compounds (“enes”). When suitable reactants are combined and exposed to an appropriate source of ultraviolet (UV) light, the thiolene reaction proceeds rapidly and quantitatively, in the presence of ambient oxygen and in the absence of added photoinitiator. These desirable properties, possessed by the thiolene chemistry, are not possessed by current state-of-the-art acrylate-based systems. For example, co-pending application entitled “Dual Cure Reaction Products Of Self-Photoinitiating Multifunctional Acrylates With Thiols And Synthetic Methods,” attorney docket number 20435/0141, assigned to the assignee of the instant application, the contents of which are hereby incorporated in their entirety and for all purposes, describes applications of thiolene chemistry with Michael addition resins.

A variety of unsaturated reactants exist for co-reaction with thiols, including, but not limited to: multifunctional vinyl compounds allylic compounds, (meth)acrylates, unsaturated polyesters, polybutadienes, and polyisoprenes.

The thiolene pressure sensitive adhesives of the present invention realize the following advantages: an essentially 100% reactive system (no solvent), and very rapid reaction at industrially useful linespeeds in the presence of ambient oxygen and in the absence of added photoinitiator, upon exposure to suitable UV light. The absence of organic solvents or water in the formulation negates the need for drying ovens, reclamation systems or incinerators, providing a direct economic benefit and environmental benefits as well. Linespeeds of 10-150 feet per minute should be easily attained, and faster linespeeds can be achieved with additional UV lamps. The absence of photoinitators, in addition to reducing costs, reduces the content of low molecular weight compounds in the adhesive and reduces the likelihood of leaching or extraction of low molecular weight organic compounds from the cured adhesive. The good reactivity in the presence of atmospheric oxygen negates the need for nitrogen or other inerting gases to blanket the adhesive during cure, thus simplifying the process and further reducing costs.

The rapid polymerization (double bond conversion) is an essentially instantaneous reaction because, as is known to the art, the thiyl radical is extremely reactive, and even the slow step, the transfer reaction, is as fast or faster than most known propagation steps in chain-growth polymerization. Reaction rates may be determined through the use of photo DSC. The degree of double bond conversion may be determined via FTIR or ¹³C NMR. Double bond conversion provides a means to measure the quantitative nature of the reaction.

### SUMMARY OF INVENTION

The present invention provides a UV-curable adhesive composition comprising a vinyl-ether terminated urethane and a poly-functional mercaptan.

The present invention provides that the UV-curable adhesive composition comprises urethanes synthesized from at least one polyester or polyether polyol, a vinyl compound, and at least one aliphatic diisocyanate.

The present invention provides a UV-curable adhesive composition wherein the urethane has a theoretical number average molecular weight (Mn) in the range of from about 1000 to about 10,000 AMU. The molecular weight of the urethane oligomer provides a means of controlling the crosslink density of the polymerized product.

The present invention provides a UV-curable adhesive composition wherein the polyol, from which the urethane is synthesized, has a molecular weight in a range sufficient to provide a urethane oligomer having a Mn in the desired range.

The present invention provides a UV-curable adhesive composition wherein the aliphatic diisocyanate does not exhibit significant absorbance at the UV wavelengths used to excite the reaction.

The present invention provides a UV-curable, pressure-sensitive adhesive composition comprising a vinyl-ether terminated urethane and a poly-functional mercaptan.

The present invention provides a UV-curable, hotmelt adhesive composition comprising a vinyl-ether terminated urethane and a poly-functional mercaptan.

The present invention provides a thiolene composition comprising the reaction product of a vinyl-ether terminated urethane and a poly-functional mercaptan, wherein the composition is crosslinked with a curing agent. A preferred curing agent is ultraviolet light.

The present invention provides a thiol-ene formulation that is curable to a crosslinked polymer. The inventive thiol-ene formulation comprises a polyfunctional mercaptan and a vinyl-terminated urethane.

The present invention further provides an adhesive product comprising at least a layer of a backing material; and a layer of a curable thiol-ene formulation which comprises a polyfunctional mercaptan, and a vinyl-terminated urethane. The thiolene layer is cured to a crosslinked polymer.

An aspect of the present invention provides a method of using a curable thiol-ene formulation. The method comprises providing a backing material and providing on the backing material a layer of a curable thiol-ene formulation and curing the thiol-ene formulation. The thiol-ene composition comprises a polyfunctional mercaptan, and a vinyl-terminated urethane.

An aspect of the present invention provides a thiol-ene formulation curable to a crosslinked polymer comprising a polyfunctional mercaptan; a vinyl-terminated urethane, and optionally further comprising odorants, stabilizers, tackifiers, colorants, rheological modifiers, fillers, and other agents.

Still other objects and advantages of the present invention will become readily apparent by those skilled in the art from the following detailed description, wherein it is shown and described preferred embodiments of the invention, simply by way of illustration of the best mode contemplated of carrying out the invention. As will be realized the invention is capable of other and different embodiments, and its several details are capable of modifications in various obvious respects, without departing from the invention. Accordingly, the description is to be regarded as illustrative in nature and not as restrictive.

### BRIEF DESCRIPTION OF DRAWINGS

FIG. 1 is a schematic of a representative thiolene compound of the present invention.

FIG. 2 is a schematic of a representative urethane oligomer of the present invention.

### DETAILED DESCRIPTION OF A PREFERRED EMBODIMENT

Reference is made to the figures to illustrate selected embodiments and preferred modes of carrying out the invention. It is to be understood that the invention is not hereby limited to those aspects depicted in the figures.

The compositions of the present invention are obtained by mixing a suitable oligomer with a polyfunctional mercaptan. The present invention confers economic and environmental advantages because no solvent, processing additives, or exogenous photoinitiator is required. The reagents are mixed preferably at a functional group ratio within 5% of stoichiometric. More preferably, the reagents are mixed at an equivalent functional group stoichiometry. However, any ratio is acceptable so long as the final product retains suitable adhesive strength.

A vinyl-ether terminated urethane oligomer is a preferred oligomer. Other classes of oligomers, such as polyesters, polybutadienes, epoxies, and acrylics are also suitable for purposes of the present invention. Generally, any ene-terminated oligomer may be used for purposes of the present invention. Vinyl-ethers are advantageous because they tend to resist homopolymerization under free-radical conditions. Allylic-ethers may also be used, but, vinyl groups are preferred because, as determined by photo differential scanning calorimetry (photo DSC), they are more reactive to thiol upon UV exposure.

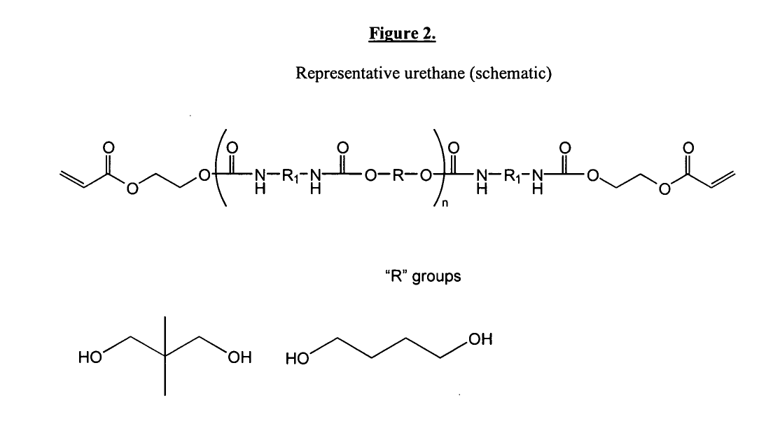

FIG. 2 is a schematic representation of a representative urethane of the present invention. The urethane oligomers of the present invention may be described as comprising three covalently-linked groups: a polyol reacted with excess diisocyanate, which is capped by a hydroxyl-containing vinyl ether. The urethane oligomers were made using a “charge-all” procedure wherein the various reactants are blended prior to commencement of the reaction by addition of catalyst.

For purposes of the present invention, vinyl terminated urethanes were synthesized from polyether or polyester polyols having number average molecular weights (Mn) in the range of from about 1000 to 4000 MW. A critical element of adhesive performance in addition to the adhesive material's inherent surface properties is the crosslink density of the polymer network. Control of this parameter can have a significant impact on the flow and wetting behavior of the adhesive, its T_{g}, and cohesive strength. For example, blends of acrylate monomers and multifunctional acrylate oligomers are used to produce both UV-curing pressure sensitive adhesives (PSAs) and rigid coatings. Although individual components may vary, the fundamental difference is that the coating formulation contains a higher proportion of multifunctional acrylates relative to the pressure sensitive adhesive, the multifunctional acrylates tend to be lower molecular weight relative to those in the UV-PSA, and the multifunctional acrylates in the coating tend to be higher in functionality, i.e., possess a greater number of acrylate functional groups per molecule, than the multifunctional acrylates employed in the UV-PSA. The functionality (number of functional groups per molecule) as well as molecular weights of the reactants thus control crosslink density. The end result is that the pressure sensitive adhesive is elastic, has a glass transition temperature (T_{g}) well below room temperature, usually below 0° C., an more often in the range of from about −80° C. to about 0° C. A PSA deforms and flows under light hand pressure. Conversely, a rigid coating may have a T_{g} well above 40° C., tends to show little flexibility or deformation under pressure, and possesses high resistance to scratching and abrasion.

Aliphatic diisocyanates are used to minimize absorbance of ultraviolet (UV) light during cure. Because the isocyanate moiety incorporated into the urethane confers sensitivity to UV light, the present invention realizes economic and environmental advantages of not requiring any exogenous photoinitiator. A preferred aliphatic diisocyanate is Desmodur W® (Bayer Corp., Pittsburgh, Pa.), [bis(4-isocyanotocyclohexyl) methane; dicyclohexylmethane diisocyanate, CAS # 5124-30-1). 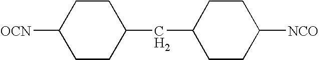
A preferred aliphatic diisocyanate is IPDI (isophorone diisocyanate; 3-isocyanato-3,5,5-trimethyl cyclohexylisocyanate, CAS # 4098-71-9. 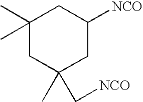
A preferred aliphatic diisocyanate is TMDI-2,2,4-trimethylhexamethylene diisocyanate, CAS #015646-96-5

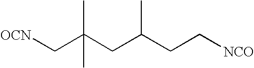

The urethanes of the present invention have a theoretical Mₙ greater than 1500 Daltons. The urethanes of the present invention were synthesized so as to have higher molecular weights and lower functionality (vinyl termination) than would be desirable for a rigid coating. It is preferred that a PSA have a vinyl functionality of 2 to 3, more preferably 2. In contrast, rigid coatings preferably have vinyl functionality greater than 3.

An aspect of the present invention provides a thiol compound to react with and crosslink the disclosed urethanes. A preferred thiol is a liquid, miscible with the acrylate oligomers and monomers of the present invention. A preferred thiol has a low molecular weight, preferably a molecular weight less than about 500 AMU and more preferably about 399 AMU. The thiol of the present invention must be at least difunctional in order to effect crosslinking of the pendant acrylate groups. A preferred di-functional mercaptan is ethylene bis(3-mercaptopropionate). Suitable di-functional mercaptans include, but are not limited to, dimethyl bis(3-mercaptopropyl)silane, 1,6-hexanedithiol, 1,10-decanedithiol, and 3,6-Dioxaoctane-1,8-dithiol.

A preferred tri-functional mercaptan is trimethylolpropane tris(trimercaptopropionate) [trimethylol propane (tris-mercaptopropionate, (TMPTMP)]. Suitable tri-functional mercaptans include, but are not limited to, triethyl-1,3,5,-triazine-2,4,6-trione tris(3-mercaptopropionate).

A preferred polyfunctional mercaptan is pentaerythritol tetrakis(3-mercaptopropionate). Suitable polyfunctional mercaptans include, but are not limited to products of propylene glycol, butanediol, hexanediol, cyclohexanedimethanol, glycerol, polyethylene glycol, polypropylene glycol, or other glycols; polyester-polyols; and other compounds with multiple hydroxyl functionality, esterified with 3-mercaptopropionic acid.

Preferably, the mercaptan has three thiol functional groups. Mercaptans with as few as two thiol groups or more than three thiols are also within the concept of the invention. Trimethylolpropane tris(trimercaptopropionate), a preferred mercaptan, has a molecular weight of 399 AMU. The present invention is also suitably practiced using blends or mixtures of two or more distinct thiols.

### EXAMPLE 1

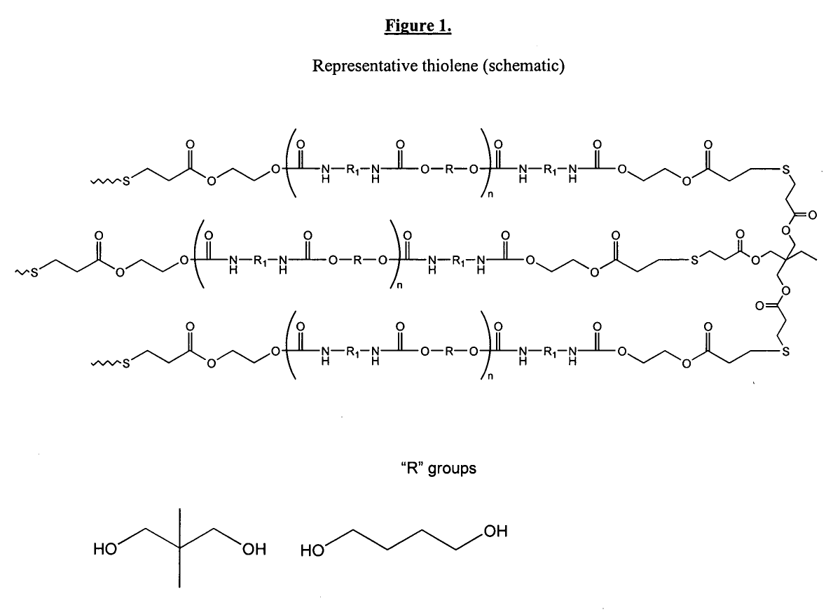

Vinyl ether-terminated urethane oligomers were synthesized from polyester polyols in the 3200 MW (M_{N}) range. The diisocyanate was Desmodur W® (Bayer) and hydroxybutyl vinyl ether provided the vinyl termination. The resulting urethane had a theoretical M_{N} of 3956. Trimethylolpropane tris(trimercaptopropionate) was used as the crosslinker at 6 wt %. (The batch of TMPTMP used had a sulfhydryl number (SH#)=419. NMR analysis indicated that the TMPTMP was a mixture 88 mole % trifunctional mercaptan and 12 mole % difunctional mercaptan). No photoinitiators, additional co-reactants, or other additives were included. Adhesive compositions were heated and cast on polyethylene terephthalate (PET) film. The adhesive layer was applied to a thickness of about 3-4 mils using a Baker bar and a draw-down technique as is known to the art. The film was then cured in air using a single 500 mJ/cm² (40 ft/min) exposure by a 600 W/in Fusion® H bulb. The cohesive strength of the adhesive formulation was measured by a hanging shear test using a 1 kg weight suspended from a 1″ by 1″ portion of film adhered to a stainless steel substrate. The formulation successfully passed 300 hours at room temperature. A value of 3.9 pli (pounds per linear inch) was observed for a 24 hour peel; a value of 1.7 pli was observed for a 15 minute peel. A value of 2.4 psi was observed when tested by loop tack. FIG. 1 is a schematic of a representative thiolene.

### EXAMPLE 2

The conditions of Example 2 were essentially the same as for Example 1 except that the diisocyanate was IPDI. The reaction yielded a urethane having a 3876 theoretical MW. Samples were successfully tested to in excess of 300 hours in a hanging shear test. A value of 3.0 pli was observed for a 15-minute peel, a value of 4.5 was observed for a 24 hour peel, and a value of 2.4 psi was determined for a loop tack.

### EXAMPLE 3

The conditions of Example 3 were essentially the same as for Example 1 except that the diisocyanate was TMDI. The reaction yielded a urethane having a 3852 theoretical MW. Samples were successfully tested to in excess of 300 hours in a hanging shear test. A value of 2.2 pli was observed for a 15-minute peel, a value of 4.4 was observed for a 24 hour peel, and a value of 2.6 psi was determined for a loop tack.

### EXAMPLE 4

The urethane oligomer was synthesized from Lexorez® 1640-35 (TM Inolex Chemical Co) a polyester polyol, IPDI as the diisocyanate (Degussa) and hydroxybutylvinyl ether. The urethane had a theoretical MW of 3709. Gel permeation chromatography (GPC) (Polymer Labs Plgel 500 Å/10⁴ Å column, 36° C., tetrahydrofuran mobile phase, 1 ml/min flow rate Waters Instruments instrumentation including pumps and injectors, calibrated against polystyrene standards, Polymer Labs) revealed a major peak (MN=6675, MW=15242, PDI=2.28) and aminor peak (Mₙ=325, Mw=432, PDI=1.33). The thiol-ene formulation comprised 6.7 wt % trimethylolpropane tris(trimercaptopropionate) and 93.3 wt % oligomer.

### EXAMPLE 5

The urethane oligomer was synthesized from Lexorez® 1640-35 (TM Inolex Chemical Co) a polyester polyol, IPDI as the diisocyanate (Degussa) and hydroxybutylvinyl ether. The urethane had a theoretical MW of 3709. Gel permeation chromatography (GPC) revealed a major peak (MN=6691, MW=15131, PDI=2.26) and aminor peak (Mₙ=318, M_{w}=428, PDI=1.35). The thiol-ene formulation comprised 6.7 wt % trimethylolpropane tris(trimercaptopropionate) and 93.3 wt % oligomer.

TABLE I

| | Oligomer | 15 Min | 24 Hour | Loop Tack | SAFT |
|---|---|---|---|---|---|
| Example | (Mₙ) | Peel (pli) | Peel (pli) | (psi) | (° F.) |
| 1 | 3956 (Theor) | 1.7 | 3.9 | 1.4 | — |
| 2 | 3876 (Theor) | 3.0 | 4.5 | 2.4 | — |
| 3 | 3852 (Theor) | 2.2 | 4.4 | 2.6 | — |
| 4 | 6675 | 4.5 | 5.4 | 6.1 | 510 |
| 5 | 6691 | 4.4 | 6.4 | 7.5 | 512 |

The temperature resistance of the formulation of Examples 4 and 5 was further tested by the hanging shear method at an elevated temperature (350° F.). A sample of such a formulation successfully passed 504 hours.

The adhesive formulations of the present invention may optionally comprise a “tackifier.” A tackifier is a material, such as a rosin ester, added to synthetic resins or adhesives to improve the initial tack of the adhesive film.

The term “pressure sensitive” designates a distinct category of adhesive that, in dry (solvent free) form, is aggressive and permanent or removable at room temperature and adheres to a variety of surfaces without the need of more than finger or hand pressure. Requires no activation by water, solvent or heat and has sufficient cohesive strength so it can be handled with the fingers.

The term “hotmelt” or “hot melt adhesive” refers to a pressure-sensitive adhesive that is formulated to be applied to a liner or backing material in a hot molten form which then cools to form a conventional pressure-sensitive adhesive.

The cohesive strength of the inventive pressure-sensitive adhesives is measured by shear testing. A shear test is performed by separating two adhesive bonded materials by forcing (either by compression or tension) the interfaces to slide over each other. The force exerted is distributed over the entire bonded area at the same time. Strengths are recorded in pounds per square inch.

Static Shear: A ½″×2″ sample is cut and the liner is folded back on one end of the strip. The exposed adhesive is attached to the edge of a stainless steel panel so that a ½″ square is attached. The panel is placed in a holder with the label facing down and either a 250 or 500 gram weight is suspended from the label. The shear test measures the time required to pull the label from the panel, perpendicular to the surface of the panel. The test measures the internal or cohesive strength of the adhesive. Soft adhesives with low internal strength will split and fall off of the panel in a shorter time than firm adhesives.

Shear Adhesion Failure Temperature (SAFT). This test measures the cohesive strength of a product when subjected to heat. A shear test is conducted in an oven that gradually and continuously rises in temperature, preferably at a rate of 5° F./sec. The temperature at which the product finally fails is called its SAFT temperature.

Peel Adhesion: A label sample, comprising at least a backing material with a layer of adhesive applied thereto, is cut into a strip 1″×8″ and applied to the test substrate under controlled conditions. With the use of an Instron®, the label is removed, after a prescribed length of time, and at a specific speed and angle. The force required to remove the label is measured in pounds/inch, and is considered the Peel Adhesion. Peel adhesion data can be obtained by removing the material at an angle of 180° or 90° to the surface. Typical paper products are evaluated at 90°. The duration between application and removal can be varied from 10 minutes to days or weeks later to evaluate the change in adhesive performance over time.

Tack: Quick adhesion. The property of a pressure-sensitive label which causes it to adhere to a surface instantly with a minimum of pressure and contact time as measured by TLM Tester or equivalent equipment.

Loop Tack: A label sample is cut into a strip 1″×8″ and is formed into a loop with the adhesive on the outside. The loop is lowered into contact with the test substrate, relying on the stiffness of the facestock to regulate the force applied. Immediately, the label is removed and the force required to remove the label is measured in pounds/inch.

Wet-out is the bonding of the adhesive to the substrate whereby any air entrapment between the adhesive and the substrate is eliminated. Example: During initial contact, wet-out percentages range from 70% to 80%. After 24 hours the adhesive flow should bring this to ultimate wet-out—100%. This is especially crucial when extreme clarity is needed for the increasingly popular “no label look”.

The composition of the present invention may include other ingredients or formulating agents as appropriate to impart desired properties to the final product. Non-limiting examples of such additional ingredients include: polymerization inhibitors and/or antioxidants, that may be included to extend shelf life and pot life; tackifiers, which may be included to improve tack and/or initial wetting ability of the composition; flow and leveling agents, which may be added to improve processing, flow, and application prior to cure; pigments, which may be added to give a desired color; fillers, which may be added to reduce cost and/or to enhance the physical and/or mechanical properties of the liquid composition and/or final cured product; odor-masking agents; which may be added to cover potentially objectionable odors from thiols present prior to cure; and UV stabilizers, which may be added to enhance weatherability.

The adhesive formulations of the present invention may be applied to a substrate using a hot melt coating laminator. A hot melt coating laminator is a devise well known in the art and persons of skill would be familiar, given the present disclosure, with how to practice the present invention using such a device.

### Incorporation by Reference

All publications, patents, patent applications, and ASTM test methods cited in this specification are herein incorporated by reference, and for any and all purposes, as if each individual publication, patent, patent application, or ASTM method were specifically and individually indicated to be incorporated by reference. In the case of inconsistencies the present disclosure will prevail. Most especially, the entire contents of U.S. Pat. Nos. 5,945,489 and 6,025,410; co-pending application Ser. No. 10/255,541, and co-pending applications Serial Numbers (numbers not yet assigned; Attorney Docket Numbers 20435/0141, 20435/0145, 20435/0146, 20435/0147, 20435/0148, 20435/0151, and 20435/0152) are herein incorporated by reference and for all purposes.

1. A UV-curable adhesive composition comprising:
a vinyl-ether terminated urethane; and
a poly-functional mercaptan.

2. The UV-curable adhesive composition, according to claim 1, wherein said urethane is synthesized from at least one polyester polyol and at least one aliphatic diisocyanate.

3. The UV-curable adhesive composition, according to claim 1, wherein said urethane has a molecular weight, <Mn>, in the range of 1000 to 50,000, more preferably 2000 to 12,000 and most preferably 3000 to 7000.

5. The UV-curable adhesive composition, according to claim 1, wherein said polyol has a molecular weight in the range of from about 1000 to about 3200 AMU.

6. The UV-curable adhesive composition, according to claim 1, wherein said diisocyanate is selected from the group consisting of Desmodur W, IPDI, and TMDI.

7. The UV-curable adhesive composition, according to claim 1, wherein said poly-functional mercaptan has at least 2 thiol groups.

8. The UV-curable adhesive composition, according to claim 1, wherein said poly-functional mercaptan is selected from the group consisting of
ethylene bis(3-mercaptopropionate),
trimethylolpropane tris(2-mercaptoacetate),
trimethylolpropane tris(3-mercaptopropionate),
triethyl-1,3,5,-triazine-2,4,6-trione tris(3-mercaptopropionate),
pentaerythritol tetrakis(2-mercaptoacetate),
pentaerythritol tetrakis(3-mercaptopropionate),
dimethyl bis(3-mercaptopropyl)silane,
1,6-hexanedithiol,
1,10-decanedithiol, and
3,6-Dioxaoctane-1,8-dithiol.

9. The UV-curable adhesive composition, according to claim 1, wherein said poly-functional mercaptan is a 3-mercaptopropionic acid ester of a polyhydroxy compound.

10. The UV-curable adhesive composition, according to claim 9, wherein said polyhydroxy compound is selected from the group consisting of glycols, propylene glycol, butanediol, hexanediol, cyclohexanedimethanol, glycerol, polyethylene glycol, polypropylene glycol, and polyester polyols.

11. The UV-curable adhesive composition, according to claim 1, wherein said poly-functional mercaptan is trimethylpropane tris(trimercaptopropionate).

12. The UV-curable adhesive composition, according to claim 1, further comprising at least one additive selected from the group consisting of polymerization inhibitors, antioxidants, tackifiers, flow and leveling agents, pigments, fillers, odor-masking agents, and UV-stabilizers.

13. A thiolene composition comprising the reaction product of:
a vinyl-ether terminated urethane; and
a poly-functional mercaptan, wherein
said composition is crosslinked with a curing agent.

14. The thiolene composition, according to claim 11, wherein said curing agent is ultraviolet light.

15. A thiol-ene formulation curable to a crosslinked polymer comprising:
a polyfunctional mercaptan; and
a vinyl-terminated urethane.

16. An adhesive product comprising
a layer of a backing material; and
a layer of a curable thiol-ene formulation comprising:
a polyfunctional mercaptan, and
a vinyl-terminated urethane, wherein said thiol-ene formulation is cured to a crosslinked polymer.

17. A method of using a curable thiol-ene formulation comprising:
providing a backing material;
providing on said backing material a layer of a curable thiol-ene formulation comprising:
a polyfunctional mercaptan, and
a vinyl-terminated urethane; and
curing said thiol-ene formulation.

18. The method of using a curable thiol-ene formulation, according to claim 17, further comprising applying said formulation with a hot-melt coater.

19. A hot-melt coater containing the curable thiol-ene formulation of claim 1.
